(19) United States
(12) Patent Application Publication
(10) Pub. No.: US 2010/0050519 A1
(43) Pub. Date: Mar. 4, 2010

(54) Energy gas producing process and energy gas storage material

(75) Inventors: Yasuaki Kawai, Nagoya-shi (JP); Mitsuru Matsumoto, Nisshin-shi (JP); Shinichi Towata, Nagoya-shi (JP); Yoshiaki Fukushima, Aichi-gun (JP); Qiwu Zhang, Sendai-shi (JP); Fumio Saito, Sendai-shi (JP)

Correspondence Address: OLIFF & BERRIDGE, PLC, P.O. BOX 320850, ALEXANDRIA, VA, 22320-4850, US

(73) Assignees: KABUSHIKI KAISHA TOYOTA CHUO KENKYUSHO, AICHI-GUN (JP); TOHOKU UNIVERSITY, SENDAI-SHI (JP)

(21) Appl. No.: 12/461,729

(22) Filed: Aug. 21, 2009

(30) Foreign Application Priority Data
Aug. 26, 2008 (JP) 2008-217435

(51) Int. Cl. C01B 3/02

(52) U.S. Cl. 48/127.5

(57) ABSTRACT

There is provided a process for producing an energy gas at a lower temperature and in a larger amount, as well as an energy gas storage material capable of easily taking out the energy gas. A process for producing an energy gas including a MG processing step of co-grinding a mixture of a carbon-, hydrogen-, and oxygen-containing compound, an alkali metal or compound thereof, and an alkaline earth metal or a compound thereof, thereby obtaining a MG processing product and a heating step of heating the MG processing product in an inert atmosphere, as well as an energy storage material obtained by the MG processing described above. The MG processing step preferably including adding a transition metal or a compound thereof to the mixture and co-grinding the mixture.

### BACKGROUND OF THE INVENTION

1. Field of the Invention

The present invention relates to an energy gas producing process and an energy gas storage material. More specifically, it relates to a process for producing energy gases such as hydrogen, methane, and carbon monoxide from a carbon-, hydrogen-, and oxygen-containing compound contained, for example, in biomass and plastic waste materials, and an energy gas storage material capable of releasing such energy gases.

2. Description of the Related Art

Biomass is a renewable organic resource derived from living organisms, excluding fossil resources. Further, bio-fuels include those fuels utilizing the energy of the biomass (for example, ethanol, methanol, butanol, diethyl ether, hydrogen gas, methane gas, and synthesis gas). Raw materials for the bio-fuels are versatile and include corn, sugarcane, food oil, wood, feces and urine, saw dust, corn stalk. Organic wastes that cannot be used for foods and feeds can also be utilized.

Among the bio-fuels, those in the state of alcohol can be utilized as fuels for diesel engines and they are used generally in some countries. Further, synthesis oils of bio-fuels and petroleum fuels are referred to as biomass-based fuels and have been studied as one of substitute fuels for gasoline mainly in the United States.

Further, various proposals have been made also for the method of obtaining gas fuels or solid fuels from the biomass.

For example, Non-Patent Document 1 discloses a method of generating hydrogen by co-grinding cellulose with addition of Ca(OH)₂ and Ni(OH)₂ and heating the ground mixture.

The document describes that hydrogen can be obtained selectively at about 400° C. by the method described above.

Further, Patent Document 1 discloses a method of producing hydrogen by milling treatment of a mixture of cellulose and iron powder.

The document describes that hydrogen can be produced at a normal temperature and under a normal pressure by the method described above.

Further, Patent Document 2 discloses a method of producing a solid fuel of mixing a Japanese Cypress material and magnesium hydroxide in a mortar, heating the mixture up to 290° C. in a nitrogen gas stream and keeping the same at 290° C. for one hour.

The document describes that when the cypress material is kept at 290° C. for one hour under the coexistence of magnesium hydroxide, a solid fuel with large heating value can be obtained since hydroxyl groups of cellulose contained in the cypress material are condensed by dehydration by magnesium hydroxide.

Further, Patent Document 3 discloses a method of producing a solid fuel by mixing a mixture of Norway spruce with sodium hydroxide, potassium hydroxide, calcium hydroxide, magnesium hydroxide, or barium hydroxide in a mortar and heating the mixture in air.

The document describes that when sodium hydroxide is added to the Norway spruce and the mixture is heated in air, only thermal decomposition proceeds without combustion reaction thereby obtaining a solid fuel with large heating value.

Further, Patent Document 4 discloses a method of producing hydrogen by introducing a cedar material, Ca(OH)₂, and water in an autoclave and keeping them at 650° C. and 3 to 25 atm for 10 minutes.

The document describes that

(1) the ingredient of the gas obtained by the method described above substantially includes hydrogen and

(2) the conversion ratio of water to hydrogen by biomass at a reaction temperature of 650° C. reaches maximum in the vicinity of 6 atm.

Further, Patent Document 5 discloses a method of producing hydrogen by putting cellulose, water, and a nickel metal catalyst into a pressurized reaction vessel, heating the inside of the vessel to 350° C. (saturation vapor pressure of water at 170 atm or higher) and keeping them for 60 minutes.

The document describes that hydrogen can be produced by the method described above and that the hydrogen yield is increased along with an increase of the metal catalyst.

[Non-Patent Document 1] Qiwu Zhang et al., “Generation of Hydrogen from Cellulose by Combination of Mechanochemical Treatment and Heating Method”, Pretext of 39th Autumn Meeting Lecture of the Society of Chemical Engineers, Japan.

### [Patent Document 1] Japanese Patent Application Laid-open No. 2006-312690

### [Patent Document 2] Japanese Patent Application Laid-open No. 2007-217467

### [Patent Document 3] Japanese Patent Application Laid-open No. 2008-037931

### [Patent Document 4] Japanese Patent Application Laid-open No. 2005-041733

[Patent Document 5] Japanese Patent Application Laid-open No. H08-059202

It is anticipated that petroleum exploitation will reach a peak around the year of 2030 and that the petroleum-dependent energy will run short on a global scale due to the economical prosperity of developing nations. Accordingly, it is considered that securement of energy sources from those other than fossil resources and stable storage thereof will become an important subject in several decades. One of candidates therefor is positive utilization of hydrogen-based energy. Since the hydrogen energy can be created from resources other than fossil resources, it places great expectation.

As disclosed in Patent Documents 4 and 5, when steam or oxygen is added to a finely pulverized biomass material and it is reacted under a high temperature and a high pressure, the material is gasified and a hydrogen gas at a relatively high purity can be obtained.

However, since the method requires reaction under a high temperature and high pressure, it needs a large scale apparatus or exhaust gas purification apparatus. Further, since necessary heat is obtained by burning a portion of the raw material, this involves a problem of low efficiency for the entire process. Further, tar may be generated depending on the reaction condition.

On the contrary, as disclosed in Non-Patent Document 1, the method of mechanochemical treatment of the biomass material with addition of additives such as Ca(OH)₂ or Ni(OH)₂ can produce hydrogen at a relatively high purity under a normal pressure without using a large scale apparatus.

However, for obtaining a relatively large amount of hydrogen, it is necessary to heat the mechanochemical treating product to a high temperature of about 400° C. Further, since a gas mixture containing gases other than hydrogen is formed depending on the kind of the additives, separation of gases may be necessary depending on the application use. For efficient utilization of various kinds of resources including the biomass material, a technique capable of selectively taking out the energy gas at a lower temperature and in a larger amount has been demanded.

### SUMMARY OF THE INVENTION

The present invention aims to provide an energy gas producing process capable of producing the energy gas at a lower temperature and in a larger amount, and an energy gas storage material capable of easily taking out the energy gas.

Further, the present invention aims to provide an energy gas producing process capable of producing one or plural energy gases simultaneously or selectively, and an energy gas storage material capable of easily taking out the energy gas described above.

Furthermore, the present invention aims to provide an energy gas producing process capable of producing one or plural energy gases simultaneously or selectively without generating tar and without using steam reforming, as well as an energy gas storage material capable of easily taking out the energy gas described above.

For solving the subject described above, according to a first aspect, a process for producing an energy gas of the present invention includes:

a MG processing step of co-grinding a mixture of a carbon-, hydrogen-, and oxygen-containing compound, an alkali metal or a compound thereof, and an alkaline earth metal or a compound thereof, thereby obtaining a MG processing product, and

a heating step of heating the MG processing product in an inert atmosphere.

The alkaline earth metal or the compound thereof preferably contains Ca.

Further, the MG processing step further preferably adds a transition metal or a compound thereof to the mixture and co-grinds the mixture.

According to a second aspect, the process for producing an energy gas of the invention includes:

a MG processing step of co-grinding a mixture of a carbon-, hydrogen-, and oxygen-containing compound and an alkaline earth metal or a compound thereof (excluding hydroxides), thereby obtaining a MG processing product and a heating step of heating the MG processing product in an inert atmosphere.

The alkaline earth metal or the compound thereof preferably contains Ca.

Further according to a third aspect, the process for producing an energy gas according to the present invention includes:

a MG processing step of co-grinding a mixture of a carbon-, hydrogen-, and oxygen-containing compound and an alkaline earth metal or a compound thereof, and a transition metal or a compound thereof (excluding those in which the alkaline earth metal or the compound thereof is Ca(OH)₂ and the transition metal or the compound thereof is Ni(OH)₂), thereby obtaining a MG processing product, and

a heating step of heating the MG processing product in an inert gas atmosphere.

The alkaline earth metal or the compound thereof preferably contains Ca.

An energy gas storage material includes, in a first aspect, a material obtained by co-grinding a mixture of a carbon-, hydrogen-, and oxygen-containing compound, an alkali metal or a compound thereof, and an alkaline earth metal or a compound thereof.

The energy gas storage material is preferably obtained by further adding a transition metal or a compound thereof to the mixture and co-grinding the mixture.

An energy gas storage material of the invention includes, in a second aspect, a material obtained by co-grinding a mixture of a carbon-, hydrogen-, and oxygen-containing compound, and an alkaline earth metal or a compound thereof (excluding hydroxide).

Furthermore, an energy-gas storage material of the invention includes, in a third aspect, a material obtained by co-grinding a mixture of a carbon-, hydrogen-, and oxygen-containing compound, an alkaline earth metal or a compound thereof, and a transition metal or a compound thereof (excluding those in which the alkaline earth metal or a compound thereof is Ca(OH)₂ and the transition metal or the compound thereof is Ni(OH)₂).

In a case of co-grinding the carbon-, hydrogen-, and oxygen-containing compound and heating the MG processing product to take out an energy gas, when one or more elements selected from the alkaline earth metals or the compounds thereof are present during co-grinding, or when an alkali metal or a compound thereof is present in addition thereto, one or plural energy gases can be taken out. In addition, there is no requirement of using steam reforming, and tar is not generated in this case.

Further, when the kind and the addition amount of the additive are optimized, the generation temperature for the energy gas (particularly, hydrogen gas) can be lowered, or plural energy gases can be taken out selectively.

Further, when the transition metal or the compound thereof is present during co-grinding, the generation temperature for the energy gas (particularly, hydrogen gas) can be lowered further.

### DESCRIPTION OF THE ACCOMPANYING DRAWINGS

FIG. 1A shows mass spectra for a MG processing product including cellulose/LiOH/Ca(OH)₂/Ni(OH)₂ (Example 1);

FIG. 1B shows mass spectra for a MG processing product including cellulose/Ca(OH)₂/Ni(OH)₂ (Comparative Example 1);

FIGS. 2A to 2E show mass spectra of a MG processing product in Comparative Example 2 to 6 respectively;

FIG. 3A shows a TEM photograph before heating of a MG processing product obtained in Comparative Example 1;

FIG. 3B shows a TEM photograph after heating (heating temperature: 500° C.) of a MG processing product obtained in Comparative Example 1;

FIG. 4 shows mass spectra for hydrogen from MG processing products at different molar ratios (Examples 1 to 3);

FIG. 5A shows mass spectra for hydrogen of a MG processing product containing various kinds of Li compounds;

FIG. 5B shows mass spectra for methane of a MG processing product containing various kinds of Li compounds;

FIG. 6A shows mass spectra for hydrogen of a MG processing product containing various kinds of alkali metal compounds;

FIG. 6B shows mass spectra for methane of a MG processing product containing various kinds of alkali metal compounds;

FIG. 7A shows mass spectra for hydrogen of a MG processing product containing various kinds of Ca compounds;

FIG. 7B shows mass spectra for methane of a MG processing product containing various kinds of Ca compounds;

FIGS. 8A to 8C show mass spectra for hydrogen in a MG processing product containing various kinds of Ni compounds respectively;

FIGS. 9A to 9C show mass spectra for methane in a MG processing product containing various kinds of Ni compound respectively;

FIG. 10A shows mass spectra for hydrogen in a MG processing product containing various kinds of transition metal compounds;

FIG. 10B shows mass spectra for methane in a MG processing product containing various kinds of transition metal compounds;

FIG. 11 shows mass spectra of a MG processing product containing Cu(OH)₂;

FIGS. 12A to 12C show mass spectra of a MG processing product including PE/Ca(OH)₂/Ni(OH)₂ respectively;

FIGS. 13A to 13D show mass spectra of a MG processing product including PVC/CaO/Ni(OH)₂ respectively;

FIG. 14A shows mass spectra of a MG processing product including cellulose/LiOH/Ca(OH)₂;

FIG. 14B shows mass spectra of a MG processing product including cellulose/KOH/Ca(OH)₂;

FIG. 15A shows mass spectra for hydrogen of a MG processing product including cellulose/LiOH/Ca(OH)₂;

FIG. 15B shows mass spectra for methane of a MG processing product including cellulose/LiOH/Ca(OH)₂; and

FIG. 16 shows mass spectra for CO of a MG processing product including cellulose/LiOH/Ca(OH)₂.

### DESCRIPTION OF THE PREFERRED EMBODIMENTS

A preferred embodiment of the invention is to be described specifically.

### [1. Energy Gas Production Process (1)]

An energy gas production process according to a first embodiment of the invention includes a MG processing step and a heating step.

### [1.1 MG Processing Step]

The MG processing step is a step of co-grinding a mixture of a carbon-, hydrogen-, and oxygen-containing compound, an alkali metal or a compound thereof, an alkaline earth metal or a compound thereof, and a transition metal or a compound thereof added optionally, to obtain a MG processing product.

### [1.1.1 Carbon-, Hydrogen-, and Oxygen-Containing Compound]

The carbon-, hydrogen-, and oxygen-containing compound (hereinafter referred to as “CHO compound”) means all organic compounds including C, H, and/or O. That is, the CHO compound includes not only renewable organic resources derived from living organisms (so-called biomass) but also organic compounds and wastes thereof not classified generally as the biomass. Further, the CHO compound includes not only natural products and wastes thereof, but also organic compounds synthesized, extracted or purified artificially, organic compounds derived from fossil fuels, and wastes thereof.

The CHO compound includes, specifically:

(1) products produced in agricultural, livestock, fishery, or forestry fields and wastes thereof (for example, agricultural products such as wheat, corn, potato, and sweet potato and portions of plants other than those used for food or livestock feed, livestock excreta, woods and wastes thereof, saw dusts, and fallen leaves),
(2) food wastes discharged from food processing industries and kitchens (for example, coffee extract wastes),
(3) waste paper,
(4) organic materials such as oils, fats, natural polymers, synthetic polymers, and wastes thereof (for example, polyethylene (PE), polyvinyl chloride (PVC), etc.), and
(5) sewage sludges.

While the CHO compounds may be in a moistened state, those in a dried state are preferred for smoothly proceeding decomposing reactions. Accordingly, when CHO compounds in the moistened state are used as the starting material, they are preferably dried and then served to the MG processing to be described later.

### [1.1.2 Alkali Metal or Compound Thereof]

It is considered that alkali metals or compounds thereof (hereinafter they are collectively referred to as “alkali additive”) have an effect of decomposing the CHO compounds into CO₂, H₂, CH₄, CO, H₂O, etc. Further, it is considered that certain kinds of alkali additives have an effect of further fixing CO₂ formed by decomposition in the form of carbonates.

The alkali metals (Li, Na, K, Rb, Cs, and Fr) may be used in the form of a pure metal or an alloy containing the alkali metal, or they may be used in the state of compounds.

The alkali additive includes, for example:

(1) pure metals including alkali metals, or alloys containing two or more alkali metals,
(2) oxides or complex salts containing alkali metals such as LiCoO₂, LiNiO, LiFeO, LiMn₂O₄, K₂CrO₄, K₃[Fe(CN)₆], K₄[Fe(CN)₆], and K₄Nb₆O₁₇,
(3) hydroxides such as LiOH, NaOH, and KOH,
(4) carbonates such as Li₂CO₃, Na₂CO₃, and K₂CO₃,
(5) acetates such as CH₃COOLi, CH₃COONa, and CH₃COOK,
(6) benzoates such as C₇H₅O₅Li, C₇H₅O₅Na, and C₇H₅O₅K,
(7) formates such as HCOOLi, HCOONa, and HCOOK.
Each of the alkali additives described above may be used alone, or two or more of them may be used in combination.

Among them, metals, alloys, or compounds containing Li and/or K are highly effective to lower the generation temperature of energy gases (particularly, hydrogen).

For the addition amount of the alkali additive, an optimum addition amount is selected in accordance with the kinds of the CHO compounds, the kinds of other additives to be described later, and the amounts thereof. Generally, when the addition amount of the alkali additive is insufficient, the generation temperature of the energy gas (particularly hydrogen gas) becomes higher. On the other hand, when the addition amount of the alkali additive is excessive, the ratio of the CHO compounds in the entire starting materials is decreased to decrease the releasing amount of the energy gas. Further, excessive addition of the alkali additive may raise the generation temperature of the energy gas sometimes.

For example, in a case of decomposing cellulose (C₆(H₂O)₅) under the coexistence of LiOH, 12 mol of LiOH is necessary based on 1 mol of cellulose for converting all the carbon contained in the cellulose into Li₂CO₃. In other words, 2 mol of Li is necessary based on 1 mol of carbon contained in the CHO compound. However, it is not necessary to induce and fix all the carbon contained in the CHO compound into the carbonates, and carbon may be taken out partially as a combustible gas CO depending on the application use. Further, since some of alkaline earth metals or compounds thereof to be described later have an effect of fixing the carbon into carbonates, it is not necessary either to fix all the carbon contained in the CHO compound as alkali metal carbonates.

For efficiently taking out the energy gas (particularly, hydrogen gas) from the CHO compound, the addition amount of the alkali additive is preferably from 0.5 to 2 mol based on 1 mol of carbon contained in the CHO compound.

### [1.1.3 Alkaline Earth Metal or Compound Thereof]

It is considered that the alkaline earth metals or the compounds thereof (hereinafter they are collectively referred to as “alkaline earth additive”) have an effect of decomposing the CHO compound into CO₂, H₂, CH₄, CO, H₂O, etc. in the same manner as the alkali additives. It is further considered that some of alkaline earth additives have an effect of further fixing CO₂ formed by decomposition in the form of the carbonate.

The alkaline earth metals (Be, Mg, Ca, Sr, and Ba) may be added in the state of pure metals or alloys containing the alkaline earth metals, or they may be added in the state of compounds.

The alkaline earth additive includes, for example:

(1) pure metals including alkaline earth metals, or alloys of two or more alkaline earth metals,
(2) alloys of alkaline earth metals and other metals such as Mg—Zn, Mg—Ce, and Ca—Zn,
(3) hydroxides such as Mg(OH)₂, Ca(OH)₂, and Ba(OH)₂,
(4) carbonates such as MgCO₃, CaCO₃, and BaCO₃,
(5) acetates such as (CH₃COO)₂Mg, (CH₃COO)₂Ca, and (CH₃COO)₂Ba,
(6) oxides such as MgO, CaO, and BaO,
(7) oxalates such as MgC₂O₄, CaC₂O₄, BaC₂O₄, and
(8) formates such as (HCOO)₂Mg, (HCOO)₂Ca, and (HCOO)₂Ba.
Each of the alkaline earth additives described above may be used alone, or two or more of them may be used in combination.

Among them, metals, alloys, or compounds containing Ca have an effect of differentiating generation temperatures of hydrogen gas and other energy gases (CO, CH₄, etc) to facilitate selective takeout of the hydrogen gas.

For the addition amount of the alkaline earth additive, an optimum addition amount is selected in accordance with the kinds of the CHO compounds, the kinds of other additives, and the amount thereof. Generally, when the addition amount of the alkaline earth additive is insufficient, the generation temperature of the energy gas (particularly, hydrogen gas) becomes higher. On the other hand, when the addition amount of the alkaline earth additive is excessive, the ratio of the CHO compound in the entire starting material is decreased to decrease the amount of releasing the energy gas. Further, excessive addition of the alkaline earth additive may raise the generation temperature of the energy gas sometimes.

For example, in a case of decomposing cellulose (C₆(H₂O)₅) under the coexistence of Ca(OH)₂, 6 mol of Ca(OH)₂ is necessary based on 1 mol of cellulose for converting all the carbon contained in the cellulose into CaCO₃. In other words, 1 mol of Ca is necessary based on 1 mol of carbon contained in the CHO compound. However, it is not necessary to induce and fix all the carbon contained in the CHO compound into the carbonate, and carbon may be taken out partially as a combustible gas CO depending on the application use. Further, since some of the alkali additives described above have an effect of fixing the carbon into carbonates, it is not necessary either to fix all the carbon contained in the CHO compound as alkaline earth metal carbonates.

For efficiently taking out the energy gas (particularly, hydrogen gas) from the CHO compound, the addition amount of the alkaline earth additive is preferably from 0.25 to 1 mol based on 1 mol of carbon contained in the CHO compound.

### [1.1.4 Transition Metal or Compound Thereof]

It is considered that transition metals or the compounds thereof (hereinafter they are referred to collectively as “transition metal additive”) have a catalytic function in the reaction for decomposing the CHO compound to generate various kinds of energy gases. Accordingly, while the transition metal additives are not always necessary, generation of the various kinds of energy gases can be promoted when they are used in combination with the alkali additive and/or the alkaline earth additive.

In the invention, “transition metal” means group 3 to 11 elements (₂₁Sc to ₂₉Cu, ₃₈Y to ₄₇Ag, ₅₇La to ₇₉Au, ₉₀Ac to ₁₁₁Rg). The transition metals may be added in the form of metals or alloys, or may be added in the state of compounds.

The transition metal additive preferably contains first transition elements (₂₁Sc to ₂₉Cu). Among the first transition elements, metals, alloys, or compounds containing one or more of elements of Mn, Fe, Co, Ni, and Cu have a good catalytic function. Particularly, since the Ni compound is easily dispersed highly in a state of nano level in the CHO compounds, they are particularly suitable as the additive.

The transition metal additive includes, specifically:

(1) metals or alloys such as Ni, Ni—Cu, Ni—Fe, Ni—Mo, Ni—Cr, Ni—Cr—Fe, Ni—Mo—Cr, Ni—Si, Fe—Ni—Co, Ni—Zn, and Ni—Ti,
(2) acetates such as nickel acetate ((CH₃COO)₂Ni), cobalt(II) acetate ((CH₃COO)₂Co), copper(II) acetate, ((CH₃COO)₂Cu), iron(II) acetate ((CH₃COO)₂Fe), copper(I) acetate ((CH₃COO)Cu),
(3) halides such as nickel(II) bromide (NiBr₂), cobalt(II) bromide (CoBr₂), copper bromide (CuBr, CuBr₂), and anhydrous iron(II) bromide (FeBr₂),
(4) formates such as nickel(II) formate ((HCOO)₂Ni), and copper(II) formate ((HCOO)₂Cu),
(5) lactates such as nickel lactate (Ni(CH₃CH(OH)COO)₂), and iron(II) lactate (Fe(CH₃CH(OH)COO)₂),
(6) oxalates such as nickel oxalate (NiC₂O₄), iron oxalate (FeC₂O₄), and copper oxalate (CuC₂O₄),
(7) hydroxides such as nickel hydroxide (Ni(OH)₂), copper(II) hydroxide (Cu(OH)₂), and cobalt hydroxide (Co(OH)₂),
(8) oxides such as nickel oxide (NiO, Ni₂O₃), iron oxide (FeO, Fe₂O₃, Fe₃O₄), copper oxide (Cu₂O, CuO), and cobalt oxide (CoO, CO₃O₄), and
(9) carbonates such as nickel carbonate (NiCO₃), and cobalt carbonate (CoCO₃).
Each of various kinds of the transition metal additives described above may be used alone, or two or more of them may be used in combination.

For the addition amount of the transition metal additive, an optimum addition amount is selected in accordance with the kind of CHO compounds, and the kind of other additives, and the amounts thereof. Generally, when the addition amount of the transition metal additive is insufficient, no sufficient catalytic function can be obtained. On the other hand, when the addition amount of the transition metal additive is excessive, the ratio of the CHO compounds in the entire starting materials is decreased to decrease the releasing amount of the energy gas.

An example of the decomposing reaction of cellulose (C₆(H₂O)₅) in the coexistence of Ni(OH)₂ as one of the transition metal additives is shown in the following equations (1) and (2).

C₆(H₂O)₅+6Ca(OH)₂+0.5Ni(OH)₂→11.5H₂+6CaCO₃+0.5Ni (1)

C₆(H₂O)₅+12LiOH+Ni(OH)₂→6Li₂CO₃+Ni+H₂O+11H₂ (2)

Although details for the mechanism of hydrogen generation under the coexistence of the transition metal additives are not apparent, when it is assumed that the decomposing reaction of cellulose (C₆(H₂O)₅) proceeds in accordance with the equation (1), 0.5 mol of Ni(OH)₂ is necessary based on one mol of cellulose. Further, when it is assumed that the decomposing reaction of cellulose (C₆(H₂O)₅) proceeds according to the equation (2), 1 mol of Ni(OH)₂ is necessary based on 1 mol of cellulose.

However, it is not necessary to induce and fix all carbon contained in the CHO compound into the carbonate, and the carbon may be taken out partially as a combustible gas CO depending on the application use. Further, not only the transition metal compound but also the transition metal in the state of the metal or the alloy thereof have a catalytic function in the decomposing reaction of the CHO compound.

For efficiently taking out the energy gas (particularly, hydrogen gas) from the CHO compound, the addition amount of the transition metal additive is preferably from 0.02 to 1 mol based on 1 mol of carbon contained in the CHO compound.

### [1.1.5 MG Processing]

MG processing means mechanical co-grinding (Mechanical Grinding) of a mixture of a CHO compound and various kinds of additives. The co-grinding method is not particularly restricted, and various kinds of methods of grinding starting solid materials into a powdery material can be used. The co-grinding method includes, specifically, a method of co-grinding the starting materials by using various kinds of grinding machines such as a planetary ball mill, a vibration ball mill, and a rotary ball mill.

The MG processing is preferably carried out until at least the additives other than the CHO compound is highly dispersed in a state of several tens nm or less. Further, the MG processing is preferably carried out until both the CHO compounds and other additives are in a highly dispersed state of several tens nm or less.

Generally, the mechanochemical reaction tends to proceed easily as the energy applied to the starting materials (for example, acceleration, grinding time, etc.) during grinding is larger since a MG processing product in which finely ground starting materials are mixed uniformly is obtained.

For the MG processing, optimal conditions are selected depending on the composition of the starting mixture.

For example, in a case where the mixture does not contain the transition metal additive, a sufficient effect can be obtained even with a MG processing with relatively weak energy. It is considered to be because the alkali additive and the alkaline earth additive have an effect mainly of fixing carbon in the CHO compound as a carbonate.

In this case, the MG processing is preferably carried out such that the size for the CHO compound and various kinds of additives is 50 nm or less. It is preferred that the size of the CHO compound and the various kinds of additives is smaller and they are highly dispersed to each other.

For example, in a case of the MG processing by using a planetary ball mill, when the transition metal additive is not contained, acceleration is preferably 3 G or more. The acceleration is, more preferably, 5 G or more.

The number of rotations is preferably 200 rpm or more. The number of rotations is further preferably 400 rpm or more.

Further, the grinding time is preferably 0.5 hours or more. The grinding time is more preferably 1 hour or more.

On the other hand, in a case of adding the transition metal additive to the starting material, it is preferred to carry out a MG processing with relatively strong energy and disperse the transition metal additive in the CHO compound as uniformly and finely as possible. This is considered to be because the transition metal additive has a catalytic function in the decomposing reaction of the CHO compound.

In this case, the MG processing is preferably carried out such that not only the size of the CHO compound and the various kinds of the additives is 50 nm or less but also the size of the transition metal additive is 10 nm or less. The size of the transition metal additive is, further preferably, 5 nm or less.

It is particularly preferred that the co-grinding are carried out intensely to such an extent that the transition metal additive cannot be confirmed any more under TEM observation for the MG processing product. In other words, the MG processing is carried out preferably until the size of the transition metal additive is 5 nm or less. Such uniform and fine dispersion is further facilitated when a compound of the transition metal (particularly, hydroxide) is used as the transition metal additive.

For example, in a case of the MG processing by using a planetary ball mill, when the transition metal additive is contained, acceleration is preferably 5 G or more. The acceleration is, more preferably, 8 G or more.

The number of rotations is preferably 400 rpm or more. The number of rotations is, more preferably, 700 rpm or more.

Further, grinding time is preferably 2 hours or more. The grinding time is, more preferably, 5 hours or more.

### [1.2 Heating Step]

The heating step is a step of heating the MG processing product obtained by the MG processing step in an inert atmosphere.

Heating is carried out in an inert atmosphere (for example, in Ar or in N₂) for easily taking out a combustible gas (collecting a gas at a high efficiency) contained in the MG processing product.

The heating temperature is selected to an optimal temperature in accordance with the composition of the MG processing product and the MG processing condition. Further, in a case of using an alkaline earth additive containing Ca, different energy gases tend to be generated respectively at different temperatures. Accordingly, when the heating temperature is changed stepwise, gases at relatively high purities can be taken out while being separated from each other.

In the invention, “energy gas” means a combustible gas containing C, H or O, such as H₂, CH₄, and CO.

### [2. Energy Gas Production Process (2)]

An energy gas production process according to a second embodiment of the invention includes a MG processing step and a heating step.

### [2.1 MG Processing Step]

The MG processing step is a step of co-grinding a mixture of a carbon-, hydrogen-, and oxygen-containing compound and an alkaline earth metal and a compound thereof (excluding hydroxide) to obtain a MG processing product.

In this embodiment, only the alkaline earth metal or the compound thereof (excluding hydroxide) is used as the additive. This is different from the first embodiment.

### [2.1.1 Carbon-, Hydrogen-, and Oxygen-Containing Compound (CHO Compound)]

Since details for the CHO compound are identical with those for the first embodiment, descriptions therefor are omitted.

### [2.1.2 Alkaline Earth Metal or Compound Thereof (Alkaline Earth Additive)]

Any of alkaline earth additives other than hydroxides may be used. Further, among the alkaline earth additives excluding the hydroxides, those containing Ca are preferred. They have an effect of differentiating the generation temperature of the hydrogen gas from those of other energy gases (CO, CH₄, etc.) to facilitate selective take out of the hydrogen gas.

Since other matters regarding the alkaline earth additive are identical with those in the first embodiment, descriptions therefor are omitted.

### [2.1.2 MG Processing]

Since details for the MG processing are identical with those in the first embodiment, descriptions therefor are omitted.

### [2.2 Heating Step]

The heating step is a step of heating the MG processing product obtained in the MG processing step in an inert atmosphere.

Since details for the heating step are identical with those in the first embodiment, descriptions therefore are omitted.

### [3. Energy Gas Production Process (3)]

An energy gas production process according to a third embodiment of the invention includes a MG processing step and a heating step.

### [3.1 MG Processing Step]

The MG processing step is a step of co-grinding a mixture of a carbon-, hydrogen-, and oxygen-containing compound, an alkaline earth metal or a compound thereof, and a transition metal or a compound thereof (excluding those in which the alkaline earth metal or the compound thereof is Ca(OH)₂ and the transition metal or the compound thereof is Ni(OH)₂) to obtain a MG processing product.

In this embodiment, the alkali metal or the compound thereof (alkali additive) is not used as the additive. This is different from the first embodiment.

### [3.1.1 Carbon-, Oxygen-, and Hydrogen-Containing Compound (CHO Compound)]

Since details for the CHO compound are identical with those for the first embodiment, descriptions therefore are omitted.

### [3.1.2 Alkaline Earth Metal or Compound Thereof (Alkaline Earth Additive)]

While the alkaline earth additive is not particularly restricted, Ca and a compound thereof are preferred. They have an effect of differentiating the generation temperature of the hydrogen gas from those of other energy gases (CO, CH₄, etc.) to facilitate selective takeout of the hydrogen gas.

In a case where the transition metal additive to be described later is Ni(OH)₂, the alkaline earth additive means those other than Ca(OH)₂.

Since other matters regarding the alkaline earth additive are identical with those for the first embodiment, descriptions therefor are omitted.

### [3.1.3 Transition Metal or Compound Thereof (Transition Metal Additive)]

While the transition metal additive is not particularly restricted, those containing first transition elements (₂₁Sc to ₂₉Cu) are preferred. Among the first transition elements, metals, alloys or compounds containing one or more of elements of Mn, Fe, Co, Ni and Cu have a high catalyst function. Particularly, since the Ni compounds tend to be dispersed highly in a nano level state in the CHO compound, they are particularly suitable as the additive.

In a case where the alkaline earth additive described above is Ca(OH)₂, the transition metal additive means those other than Ni(OH)₂.

Since other matters regarding the transition metal additive are identical with those for the first embodiment, descriptions therefor are omitted.

### [3.1.4 MG Processing]

Since details for the MG processing are identical with those for the first embodiment, descriptions therefor are omitted.

### [3.2 Heating Step]

The heating step is a step of heating the MG processing product obtained in the MG processing step in an inert atmosphere.

Since details for heating step are identical with those for the first embodiment, descriptions therefor are omitted.

### [4. Energy Gas Storage Material (1)]

An energy gas storage material in the first embodiment of the invention includes a material obtained by co-grinding (MG processing) a mixture of a carbon-, hydrogen-, and oxygen-containing compound, an alkali metal or a compound thereof, an alkaline earth metal or a compound thereof, and a transition metal or a compound thereof added optionally.

In a case where the transition metal additive is contained in the mixture, it is preferably dispersed uniformly and finely in the CHO compound. Specifically, the size of the transition metal additive contained in the MG processing product is preferably 5 nm or less. Such a MG processing product is obtained by intensely co-grinding the starting mixture. Further, when the compound of the transition metal (particularly, hydroxide) is used as the transition metal additive, such uniform and fine dispersion is further facilitated.

When such a MG processing product is heated in an inert atmosphere, various kinds of energy gases are formed at various temperatures in accordance with the kind and the composition of the CHO compound and the additive.

Particularly, when the alkali metal additive containing Li and/or K is used, it is possible to take out an energy gas (particularly, hydrogen gas) at a lower temperature.

Further, when an alkaline earth additive containing Ca is used, respective energy gases are generated at different temperatures. Accordingly, not only the energy gases can be taken out at a lower temperature but also this facilitates to take out the energy gases while being separated from each other. Further, when a specified energy gas is released at a specified temperature and then the residue is heated to a higher temperature, another energy gas can be released. Further, two or more kinds of residues undergoing different hysteresis may be mixed and heated to a predetermined temperature.

Further, since the transition metal additive has a catalytic function in the decomposing reaction of the CHO compound, when the additive is added, energy gases (particularly, hydrogen gas) can be taken out at a lower temperature compared with the MG processing product not containing the same.

Since other matters regarding the CHO compound, the alkali additive, the alkaline earth additive, the transition metal additive, and the MG processing are identical with those described above, descriptions therefor are omitted.

### [5. Energy Gas Storage Material (2)]

The energy gas storage material of the invention in the second embodiment is obtained by co-grinding (MG processing) a mixture of a carbon-, hydrogen-, and oxygen-containing compound, an alkaline earth metal or a compound thereof (excluding hydroxide).

Since other matters regarding the energy gas storage material according to this embodiment are identical with those of the energy gas storage material according of the first embodiment, descriptions therefor are omitted.

### [6. Energy Gas Storage Material (3)]

The energy gas storage material according to the third embodiment of the invention is obtained by co-grinding (MG processing) a mixture of carbon-, hydrogen-, and oxygen-containing compound, an alkaline earth metal or a compound thereof, and a transition metal or a compound thereof (excluding those in which the alkaline earth metal or the compound thereof is Ca(OH)₂, and the transition metal or the compound thereof is Ni(OH)₂).

The transition metal additive is preferably dispersed in the CHO compound uniformly and finely. Specifically, the size of the transition metal additive contained in the MG processing product is preferably 5 nm or less. Such a MG processing product is obtained by intensely co-grinding the starting mixture. Further, when the compound of the transition metal (particularly, hydroxide) is used as the transition metal additive, such uniform and fine dispersion is further facilitated.

Since other matters regarding the energy gas storage material according to this embodiment are identical with those of the energy gas storage material according to the first embodiment, descriptions therefor are omitted.

### [7. The Effect of Energy Gas Production Process and Energy Gas Storage Material]

In a case of subjecting the CHO compound to the MG processing and heating the MG processing product to take out the energy gas, when one or more elements selected from the alkaline earth additives are present, or when the alkali additives are present in addition thereto, one or plural energy gases can be taken out by merely heating the MG processing product. In addition, it is not necessary in this case to use steam reforming that requires higher energy and an expensive apparatus, and tar is not generated. This is considered to be because

(1) the alkali additive and/or alkaline earth additive fix carbon contained in the CHO compound as a carbonate and, at the same time, decomposition of the CHO compound takes place to form H₂, CH₄, CO, etc. which are combustible gases,
(2) the alkali additive and the alkaline earth additive are strong bases, therefore they react due to deliquescent property thereof with carbon dioxide in air to form carbonates, and generate heat of dissolution at the instance to promote decomposing reaction of the CHO compound, or
(3) the strong base dissolves the CHO compound (particularly, protein), disconnects hydrogen bond in the molecule of the CHO compound, or changes the position of the hydrogen bond in the molecule (modification), thereby promoting the decomposing reaction of the CHO compound.

Further, when the kind and the addition amount of the additive are optimized, the generation temperature of the energy gas (particularly, hydrogen gas) can be lowered, or plural energy gases can be taken out selectively. Particularly, among the alkaline earth additives, those containing Ca have an effect of generating the H₂ gas at a lower temperature and generating a CO gas or a CO₂ gas at a higher temperature. Accordingly, when the alkaline earth additive containing Ca is added to the mixture, a H₂ gas at a relatively high purity can be taken out by merely heating.

Further, when the transition metal additive is present in the MG processing, the generation temperature of the energy gas (particularly, hydrogen gas) can be further lowered. This is considered to be because the transition metal additive has a catalytic function in the decomposition reaction of the CHO compound.

For example, when the MG processing is carried out by adding LiOH, Ca(OH)₂ and Ni(OH)₂ to the CHO compound, the starting temperature of hydrogen generation can be lowered by 100 to 150° C. compared with a case of adding only Ca(OH)₂ and Ni(OH)₂. Specifically, H₂ and CH₄ can be taken out by using a heat source at an extremely low temperature of about 200° C.

Further, when K or a compound thereof is used as the alkali additive, the starting temperature of hydrogen generation can be lowered to about 200° C. even without using the transition metal additive.

### EXAMPLE

### Example 1, Comparative Examples 1 to 6

### 1. Preparation of Specimen

Cellulose, LiOH, Ca(OH)₂ and Ni(OH)₂ are blended at a 1/3/3/1 molar ratio and subjected to the MG processing by a planetary ball mill (Example 1). The MG processing was carried out by using a planetary ball mill device P5 manufactured by Fritch Japan Co., Ltd. at the number of rotations of 400 rpm for eight hours.

In the same manner, cellulose, Ca(OH)₂ and Ni(OH)₂ were blended at a 1/6/1 molar ratio and subjected to the MG processing in a planetary ball mill (Comparative Example 1). The MG processing conditions were identical with those in Example 1.

Further, the MG processing was carried out under the same conditions as those in Example 1 also for a cellulose/Ca(OH)₂ mixture (molar ratio=1/6; Comparative Example 2), only Ca(OH)₂ (Comparative Example 3), a Ca(OH)₂/Ni(OH)₂ mixture (molar ratio=6/1; Comparative Example 4), a LiOH/Ca(OH)₂ mixture (molar ratio=1/1; Comparative Example 5), and a LiOH/Ca(OH)₂/Ni(OH)₂ mixture (molar ratio=3/3/1; Comparative Example 6).

### 2. Test Method

### [2.1 Mass Spectrometry]

The MG processing product was heated and put to qualitative analysis for generated gases by using a mass spectrometry. Mass spectrometry was carried out by automatic measurement using an automatic temperature programmed desorption analyzer manufactured by Okura Riken Co., Ltd. (TP-5000, RG-102P) while setting MS measuring conditions and automatic sequence conditions.

### [2.2 TEM Observation and XRD]

TEM observation and XRD (X ray diffraction) were carried out for MG processing product before and after heating.

### 3. Result

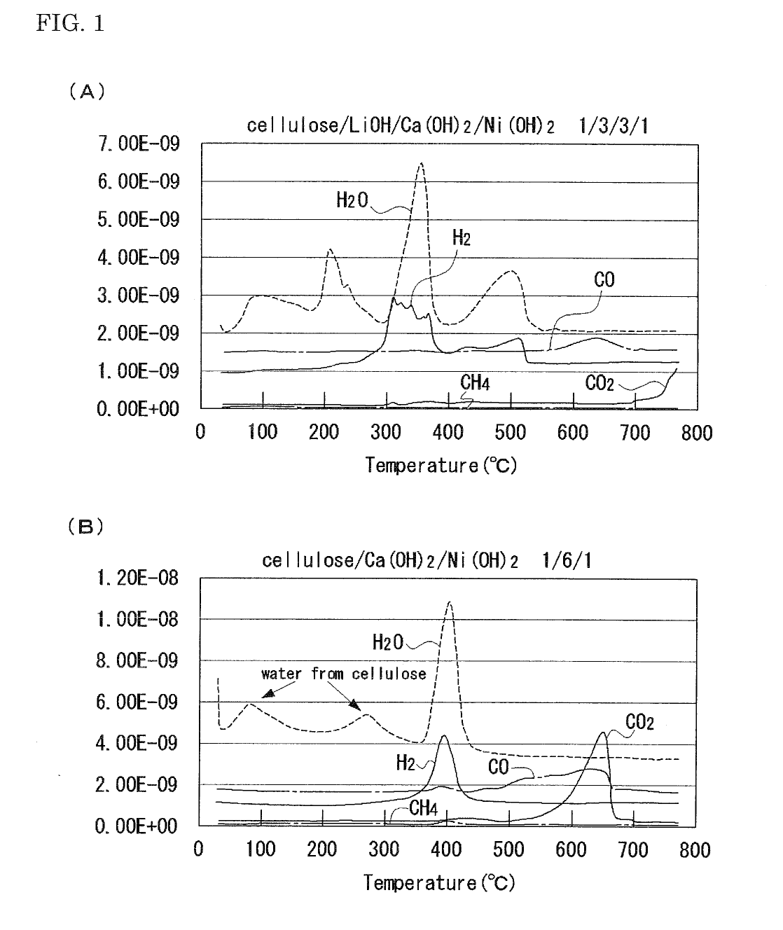

FIG. 1A and FIG. 1B show mass spectra for the MG processing product of Example 1 and the MG processing product of Comparative Example 1 respectively.

It can be seen from FIG. 1 that

(1) gases are generated in the order of H₂, CO, and CO₂ along with temperature elevation in each of Example 1 and Comparative Example 1 with addition of Ca(OH)₂, and CH₄ is generated at a temperature substantially identical with that for H₂,
(2) the starting temperature of H₂ generation, the starting temperature of CH₄ generation, the starting temperature of CO generation, and the starting temperature of CO₂ generation in the MG processing product of Example 1, are lower by 100 to 200° C. compared with those of Comparative Example 1, and
(3) the starting temperature of H₂ generation in the MG processing product of Example 1 is about 200° C.

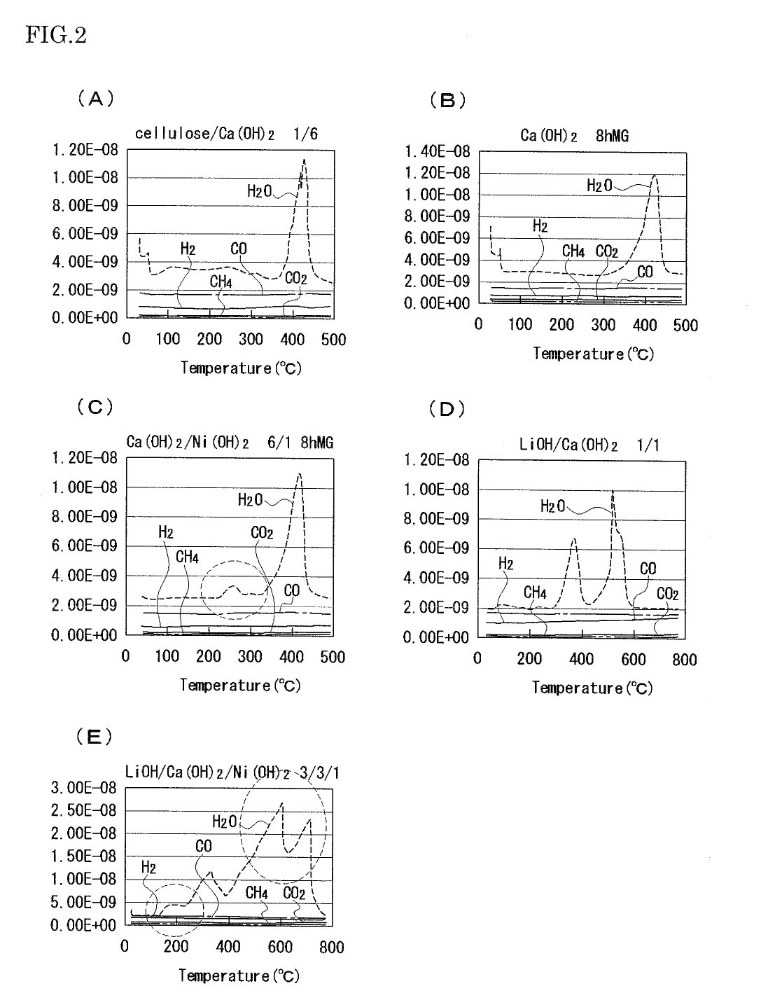

FIG. 2A to FIG. 2E show mass spectra of MG processing products of Comparative Examples 2 to 6 respectively. When a cellulose/Ca(OH)₂ mixture is heated, H₂O is generated gradually at 100 to 300° C., and H₂O is generated abruptly at about 400° C. as shown in FIG. 2A. It is considered that the former corresponds to the dehydration of cellulose while the latter corresponds to the dehydration of Ca(OH)₂ as shown in FIG. 2B.

When one of Ni(OH)₂ and LiOH is added to Ca(OH)₂, two H₂O generation peaks appear as shown in FIG. 2C and FIG. 2D. It is considered that the peak on the side of the lower temperature corresponds to dehydration of Ni(OH)₂ or LiOH. Further, it is considered that the peak on the side of the higher temperature corresponds to the dehydration of Ca(OH)₂.

Further, when both of Ni(OH)₂ and LiOH are added to Ca(OH)₂, H₂O generation peaks appear at about 200° C., about 300° C., and 600 to 700° C. It is considered that the peaks correspond to dehydration of Ni(OH)₂, LiOH, and Ca(OH)₂, respectively.

It can be seen from FIGS. 2A to 2E that when the mixture of two or more kinds of hydroxides is put to the MG processing and heated, the H₂O generation peak may shift to the lower temperature side or the higher temperature side, or the shape of mass spectra may change, compared using the MG processing product with a single hydroxide.

While hydrogen is generated by heating with respect to the MG processing product only with addition of Ca(OH)₂ to the cellulose, the hydrogen yield is relatively small as shown in FIG. 2A.

On the other hand, when Ca(OH)₂/Ni(OH)₂ is added to the cellulose, a distinct peak of hydrogen generation appears at about 400° C. as shown in FIG. 1B. In addition, when compared to the case of heating only with addition of Ca(OH)₂/Ni(OH)₂ (FIG. 2C), the mass spectrum for H₂O changes remarkably and the H₂O yield at 100 to 200° C. increases. This is considered to be because Ni(OH)₂ functions as a catalyst in the decomposing reaction of the cellulose.

Further, when LiOH/Ca(OH)₂/Ni(OH)₂ are added to the cellulose, as shown in FIG. 1A, a generation peak for hydrogen appears at about 300° C. Moreover, when compared to the case of heating only with addition of LiOH/Ca(OH)₂/Ni(OH)₂ (FIG. 2E), the mass spectrum for H₂O remarkably changes and the H₂O yield at 100 to 200° C. increases. This is considered to be because the decomposing reaction of cellulose is further promoted by coexistence of LiOH in addition to Ca(OH)₂ and Ni(OH)₂.

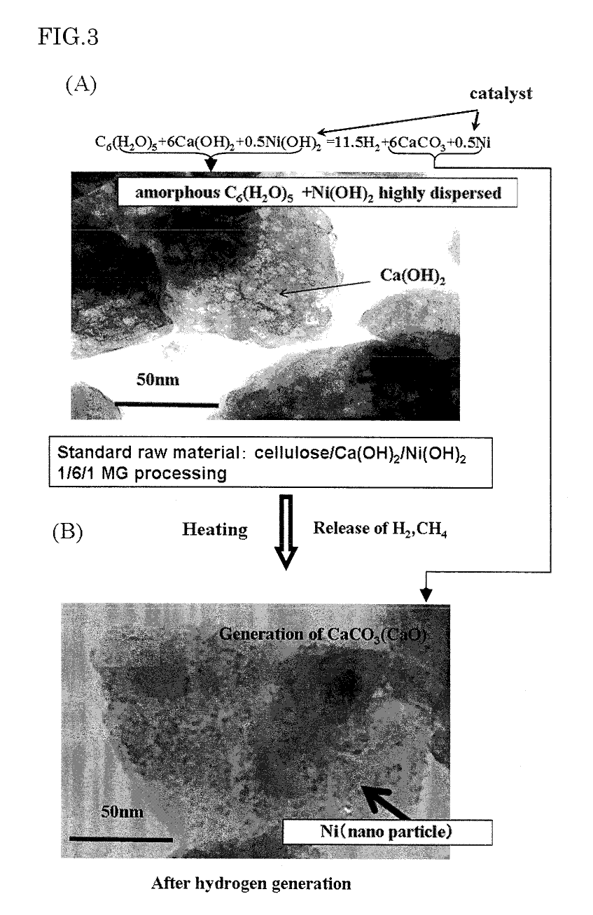

FIG. 3A shows a TEM photograph of the MG processing product before heating obtained in Comparative Example 1. Further, FIG. 3B shows a TEM photograph of the MG processing product obtained in Comparative Example 1 after heating (heating temperature: 500° C.).

It can be seen from FIG. 3 that

(1) the cellulose after the MG processing becomes amorphous (confirmed by XRD although not illustrated), and Ni(OH)₂ is dispersed in the amorphous cellulose while Ca(OH)₂ is dispersed at the periphery of the amorphous cellulose,
(2) Ni(OH)₂ dispersed in the amorphous cellulose is so highly dispersed as it cannot be observed by TEM and the size thereof is 5 nm or less, and
(3) the cellulose disappears completely, when the MG processing product is heated, into a state where Ni nano-particles of about 5 nm are dispersed in CaCO₃ (partially containing CaO).

Although not illustrated, also the MG processing product before and after heating obtained in Example 1 was in the state substantially identical with that for Comparative Example 1.

### Examples 2, 3

### 1. Preparation of Specimen

The MG processing was carried out in accordance with the same procedures as those in Example 1 except for changing the molar ratio of cellulose/LiOH/Ca(OH)₂/Ni(OH)₂ to 1/1/1/1 (Example 2) or 1/6/6/1 (Example 3).

### 2. Test Method

For the obtained MG processing product, gases generated during heating were analyzed qualitatively in accordance with the same procedures as those in Example 1.

### 3. Result

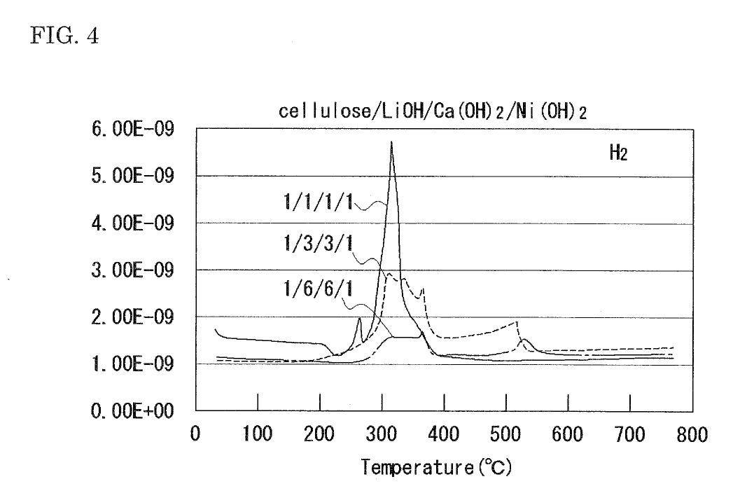

FIG. 4 shows mass spectra only for hydrogen. FIG. 4 also shows the result of the MG processing products obtained in Example 1 (molar ratio=1/3/3/1).

It can be seen from FIG. 4 that

(1) a generation peak for hydrogen is present at about 300° C. in any of the MG processing products irrespective of the molar ratio, and
(2) the intensity of the peak for hydrogen increases as the molar ratio of LiOH and Ca(OH)₂ is lower.

### Examples 4 to 7

### 1. Preparation of Specimen

Cellulose/alkali metal compound/Ca(OH)₂/Ni(OH)₂ were blended at a 1/3/3/1 molar ratio, and subjected to the MG processing in a planetary ball mill. The MG processing conditions were identical with those in Example 1. As the alkali metal compound, CH₃COOLi (Example 4), Li₂CO₃ (Example 5), NaOH (Example 6) or KOH (Example 7) were used.

### 2. Test Method

For the obtained MG processing product, gases generated during heating were analyzed qualitatively in accordance with the same procedures as those in Example 1.

### 3. Result

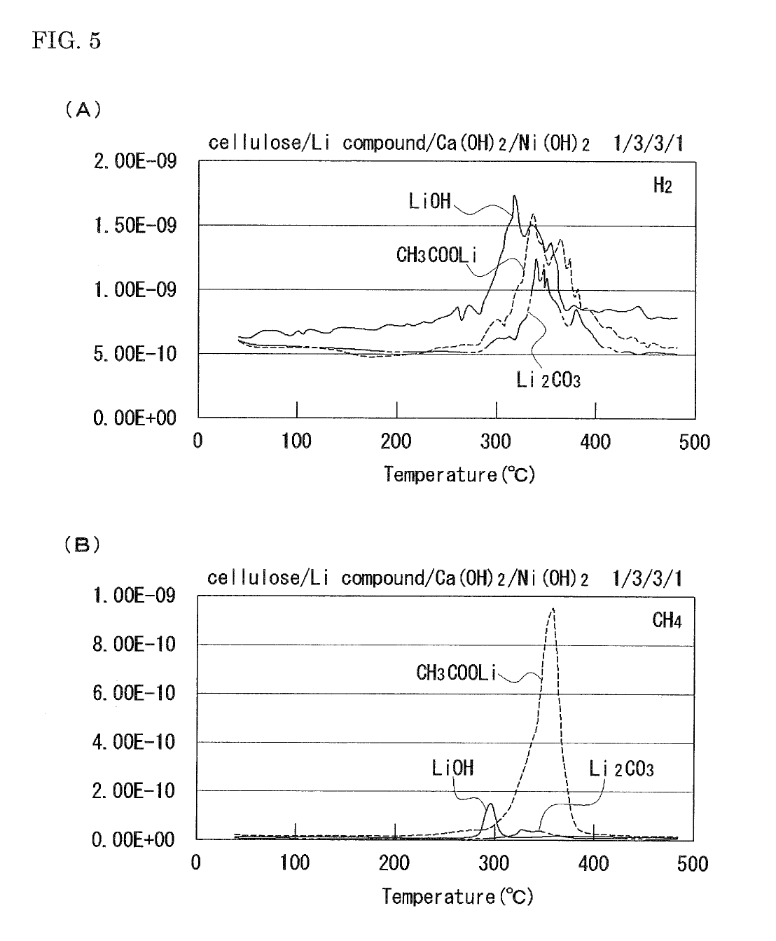

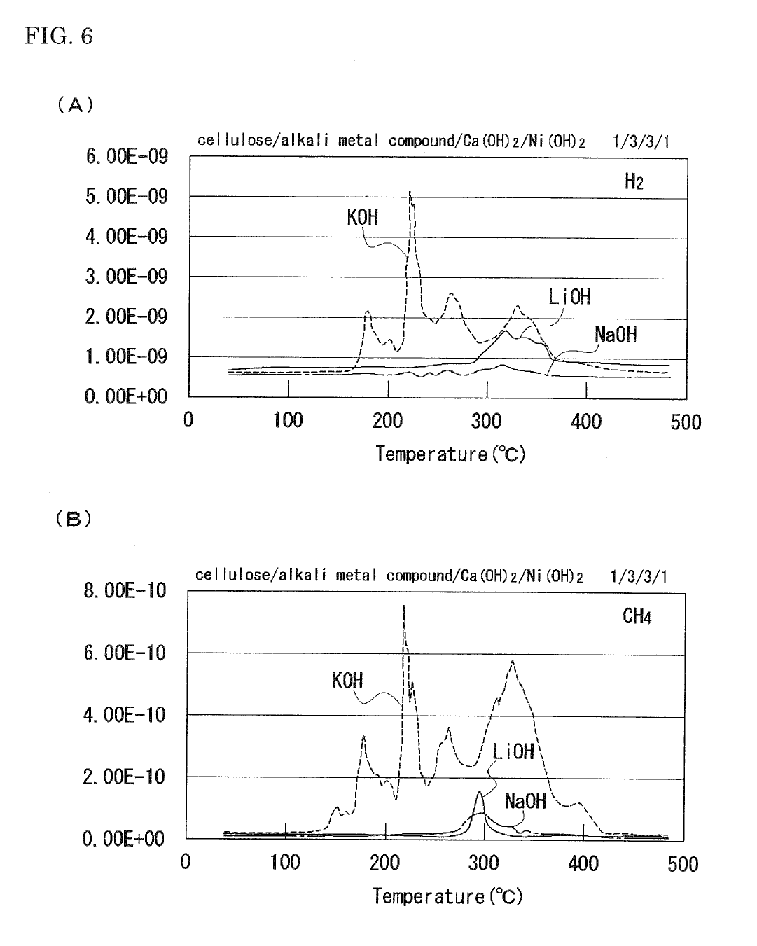

FIGS. 5A to 6B show mass spectra for hydrogen and methane of the MG processing products containing various kinds of alkali metal compounds. FIGS. 5A to 6B also show the result of MG processing products obtained in Example 1 (alkali metal compound=LiOH).

It can be seen from FIGS. 5A to 6B that

(1) hydrogen and methane can be generated from the MG processing products at about 300° C. irrespective of the kinds of alkali metal compounds,
(2) the generation ability of hydrogen and methane is in the order of K>Li>Na,
(3) the generation ability of hydrogen is in the order of LiOH>CH₃COOLi>Li₂CO₃, and
(4) the generation ability of methane is in the order of CH₃COOLi>LiOH>Li₂CO₃.

### Examples 8 to 10

### 1. Preparation of Specimen

Cellulose/Ca compound/Ni(OH)₂ were blended at a 1/6/1 by molar ratio and subjected to the MG processing in a planetary ball mill. The MG processing conditions were identical with those in Example 1. As the Ca compound, (CH₃COO)₂Ca (Example 8), CaO (Example 9) and CaCO₃ (Example 10) were used.

### 2. Test Method

For the obtained MG processing product, gases generated during heating were analyzed qualitatively in accordance with the same procedures as those in Example 1.

### 3. Result

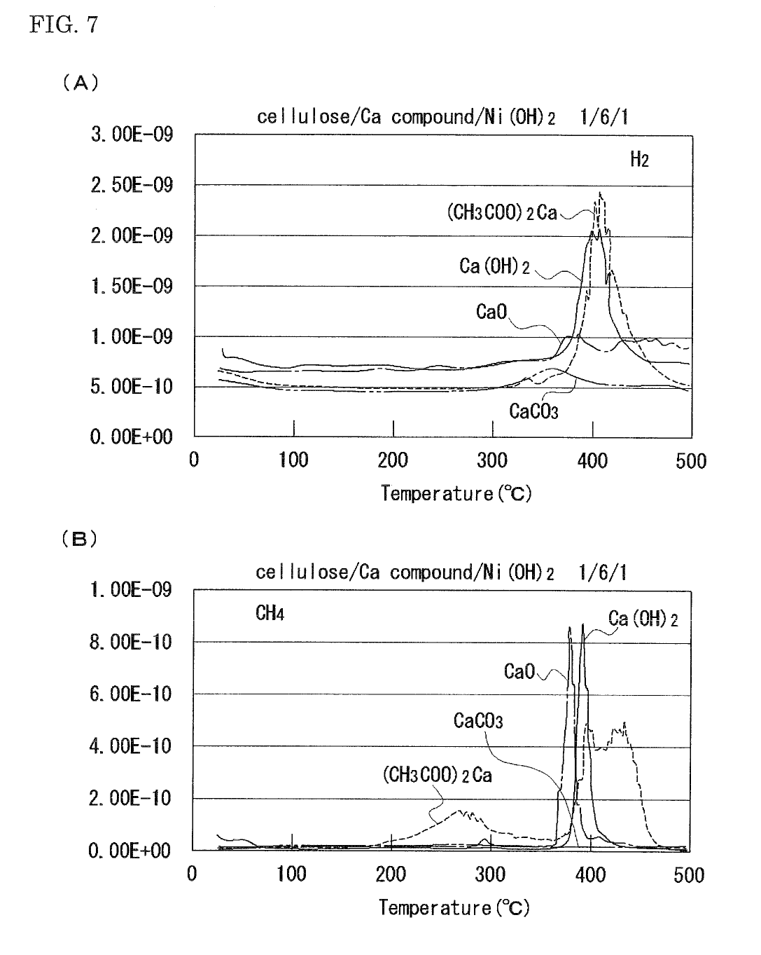

FIGS. 7A and 7B show mass spectra for hydrogen and methane of the MG processing products containing various kinds of Ca compounds. FIGS. 7A and 7B also show the result of MG processing product obtained in Comparative Example 1 (Ca compound=Ca(OH)₂)).

It can be seen from FIGS. 7A and 7B that

(1) hydrogen and methane can be generated from the MG processing products at about 400° C. irrespective of the kinds of Ca compounds,
(2) the generation ability of hydrogen is in the order of (CH₃COO)₂Ca≈Ca(OH)₂>CaO>CaCO₃, and
(3) the generation ability of methane is in the order of CaO≈Ca(OH)₂>(CH₃COO)₂Ca>CaCO₃.

### Examples 11 to 18

### 1. Preparation of Specimen

Cellulose/Ca(OH)₂/transition metal additive were blended at a 1/6/1 molar ratio and subjected to the MG processing in a planetary ball mill. The MG processing conditions were identical with those in Example 1. As the transition metal additive, Ni(NO₃)₂ (Example 11), (CH₃COO)₂Ni (Example 12), NiCl₂ (Example 13), (HCOO)₂Ni (Example 14), NiBr₂ (Example 15), PtLiCoO₂ (Example 16), Co(OH)₂ (Example 17), and Cu(OH)₂ (Example 18) were used.

### 2. Test Method

For the obtained MG processing product, gases generated during heating were analyzed qualitatively in accordance with the same procedures as those in Example 1.

### 3. Result

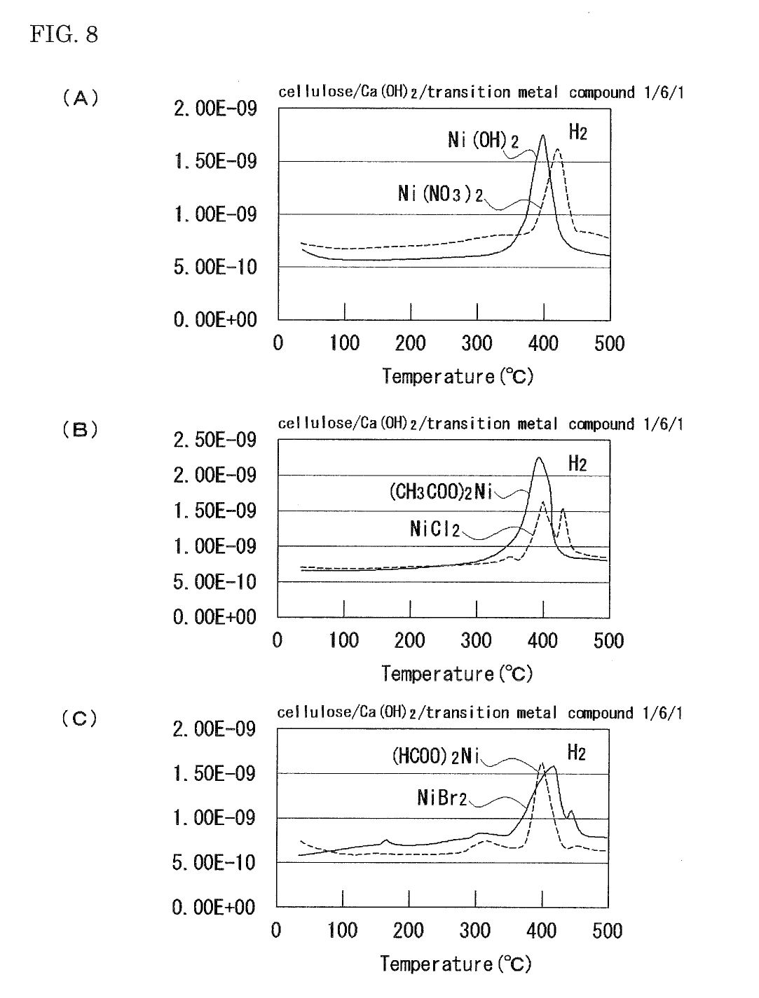

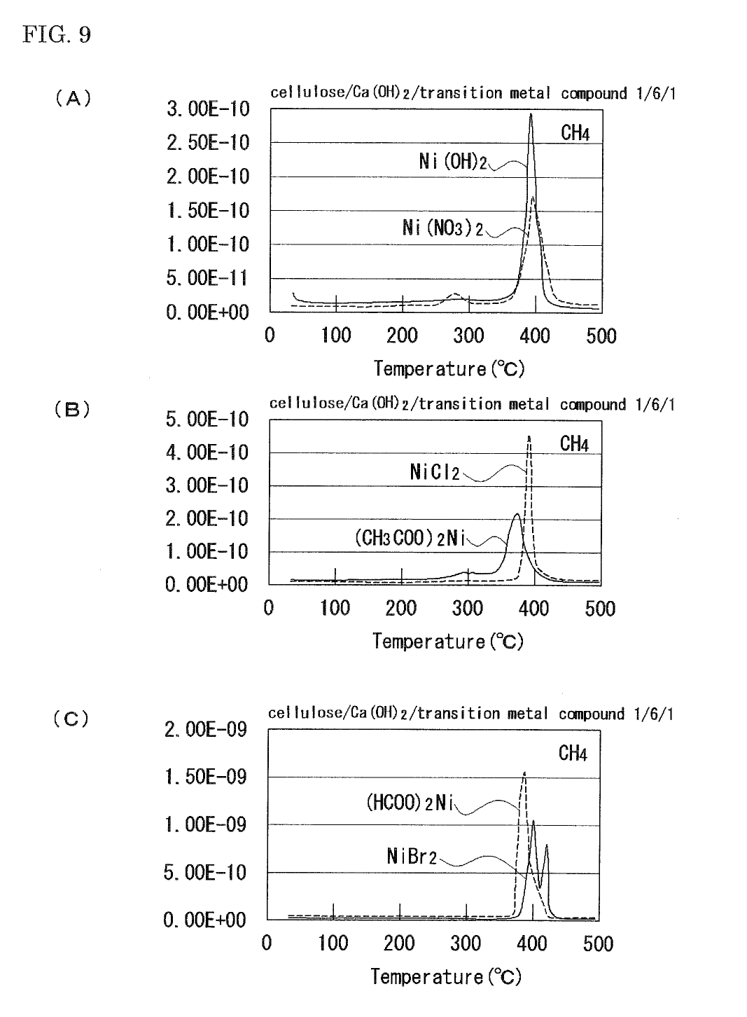

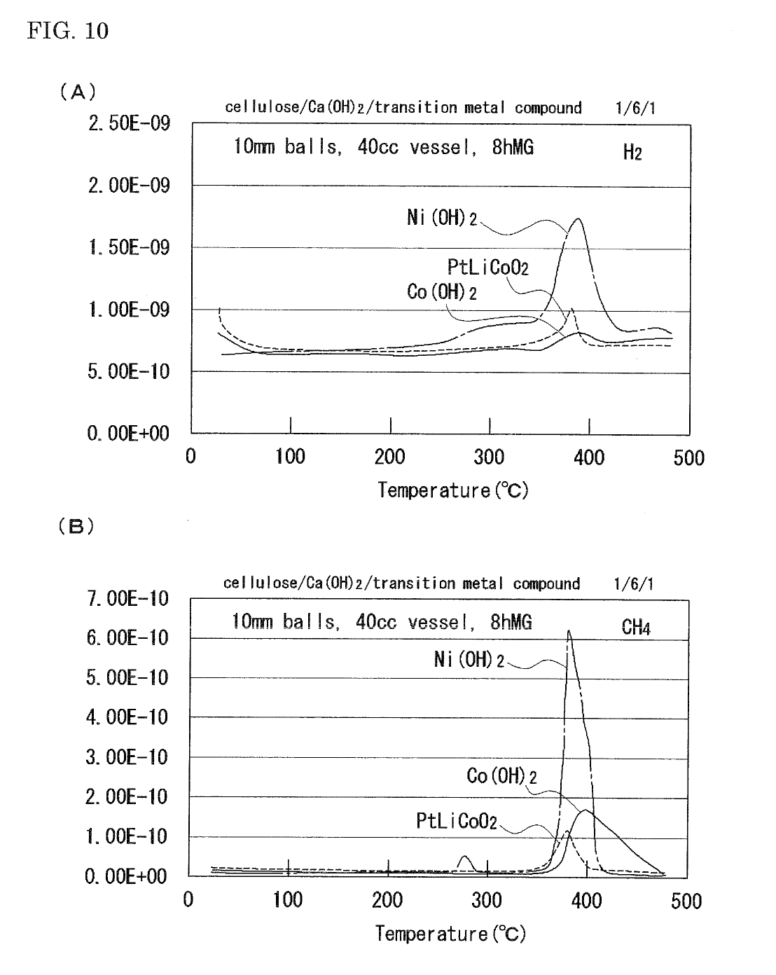

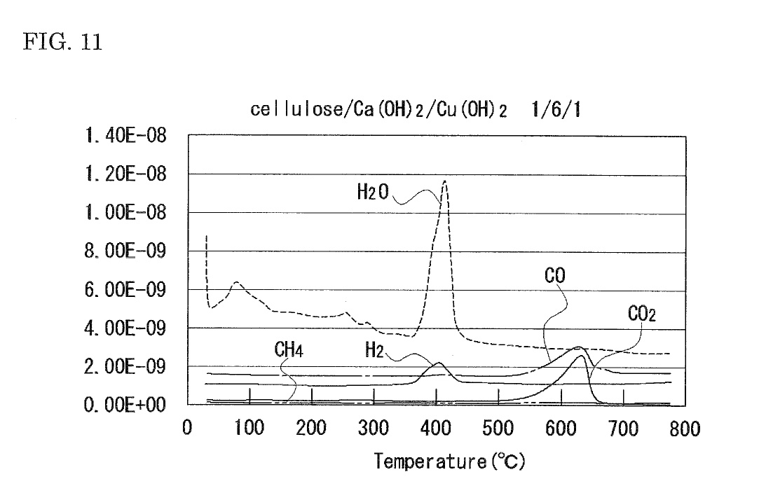

FIGS. 8A to 11 show mass spectra for each of the MG processing products containing various kinds of transition metal additives. FIGS. 8A to 10 also show the result of the MG processing product obtained in Comparative Example 1 (transition metal additive=Ni(OH)₂).

It can be seen from FIGS. 8A to 11 that

(1) hydrogen and methane can be generated from the MG processing products at about 400° C. irrespective of the kinds of the transition metal additive, and
(2) the Ni compound has a particularly high generation ability of hydrogen and methane.

### Example 19 and Comparative Example 7

### 1. Preparation of Specimen

PE (polyethylene)/Ca(OH)₂/Ni(OH)₂ were blended at C:Ca:Ni=6/6/1, 6/9/1, or 6/11/1 molar ratio and subjected to the MG processing in a planetary ball mill (Comparative Example 7).

In the same manner, PVC (polyvinyl chloride)/CaO/Ni(OH)₂ were blended at 1/3/0.1, 1/3/0.5, 1/3/1, or 1/3/2 molar ratio and subjected to the MG processing in a planetary ball mill (Example 19).

### 2. Test Method

For the obtained MG processing products, gases generated during heating were analyzed qualitatively in accordance with the same procedures as those in Example 1.

### 3. Result

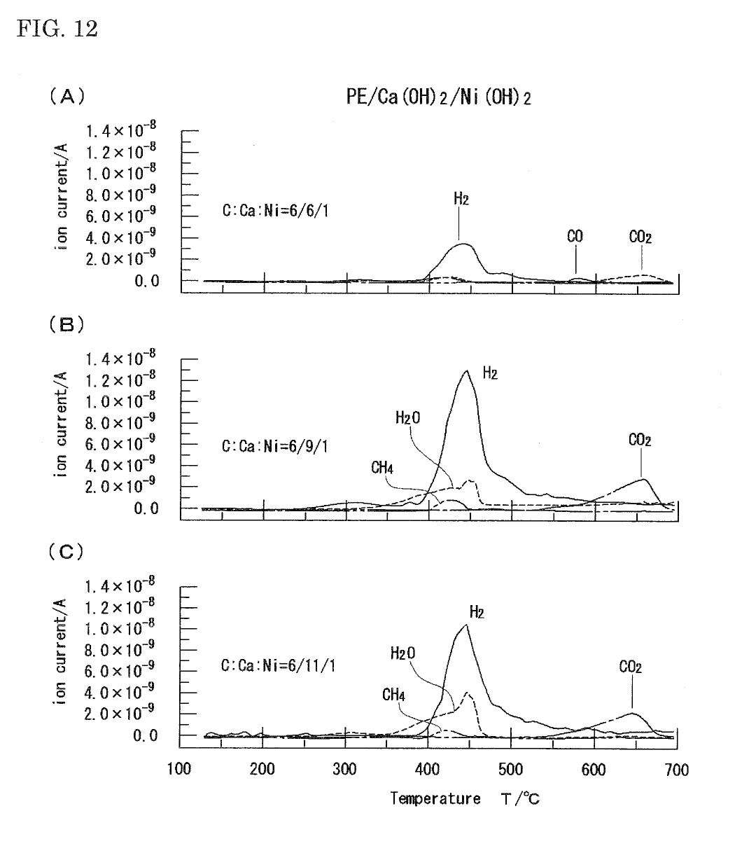

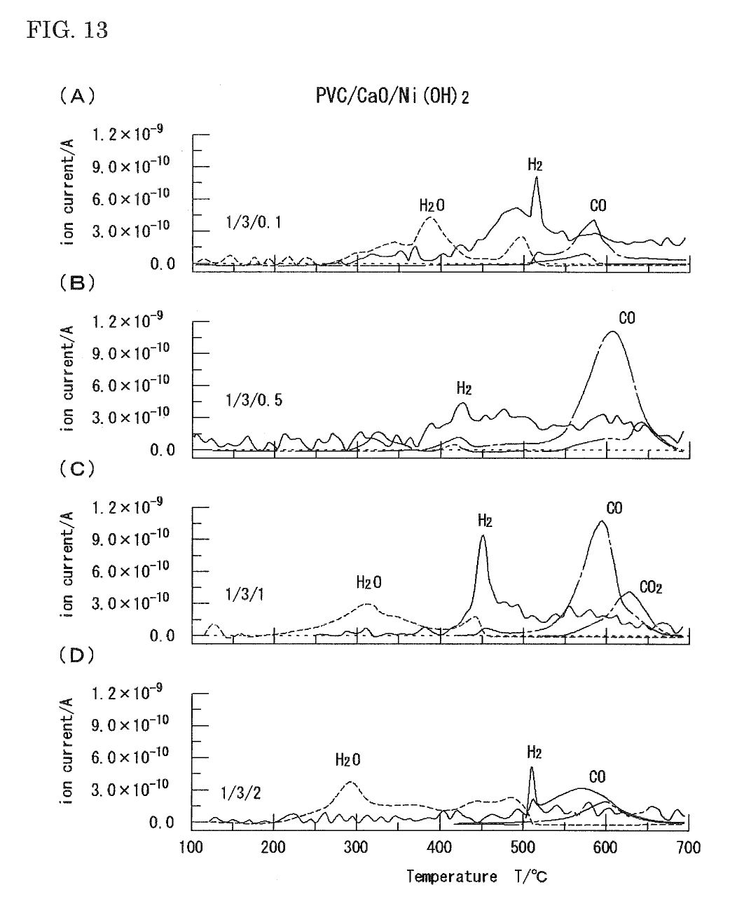

FIGS. 12A to 13D show mass spectra for each of the MG processing products.

It can be seen from FIGS. 12A to 13D that energy gases such as hydrogen, CH₄, and CO can be taken out selectively from MG processing products with Ca(OH)₂ or CaO and Ni(OH)₂ added to them, also in a case of using PE or PVC instead of the cellulose.

### Examples 20 to 21

### 1. Preparation of Specimen

Cellulose/LiOH/Ca(OH)₂ were blended at a 1/3/3 molar ratio and subjected to the MG processing in a planetary ball mill (Example 20). In the same manner, cellulose/KOH/Ca(OH)₂ were blended at a 1/3/3 molar ratio and subjected to the MG processing in a planetary ball mill (Example 21). The MG processing conditions were identical with those in Example 1.

### 2. Test Method

For the obtained MG processing products, gases generated during heating were analyzed qualitatively in accordance with the same procedures as those in Example 1.

### 3. Result

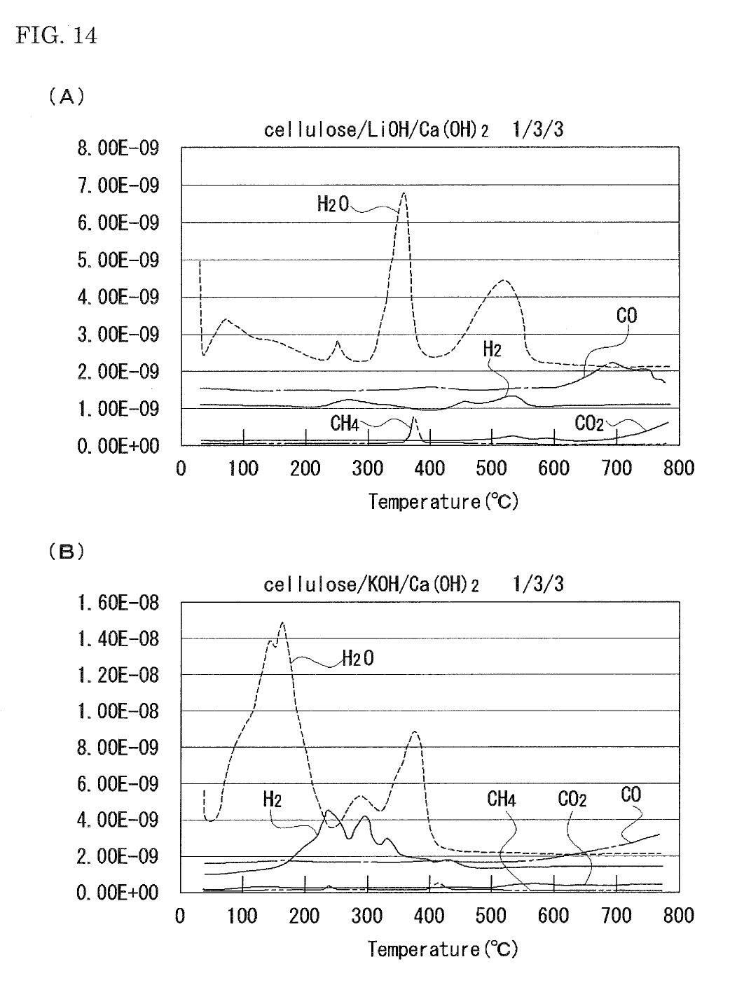

FIGS. 14A and 14B show mass spectra for each of the MG processing products.

It can be seen from FIGS. 14A and 14B that

(1) when LiOH or KOH and Ca(OH)₂ are present, energy gases such as hydrogen and CO can be taken out selectively without adding the transition metal compound, and
(2) by using KOH as the alkali metal compound, the starting temperature of hydrogen generation can be lowered to less than 200° C. without adding the transition metal compound.

### Examples 22 to 24

### 1. Preparation of Specimen

The MG processing was carried out under the same conditions as those in Example 20 except for changing the molar ratios of cellulose/LiOH/Ca(OH)₂ to 1/1/1 (Example 22), 2/1/1 (Example 23), and 4/1/1 (Example 24).

### 2. Test Method

For the obtained MG processing products, gases generated during heating were analyzed qualitatively in accordance with the same procedures as those in Example 1.

### 3. Result

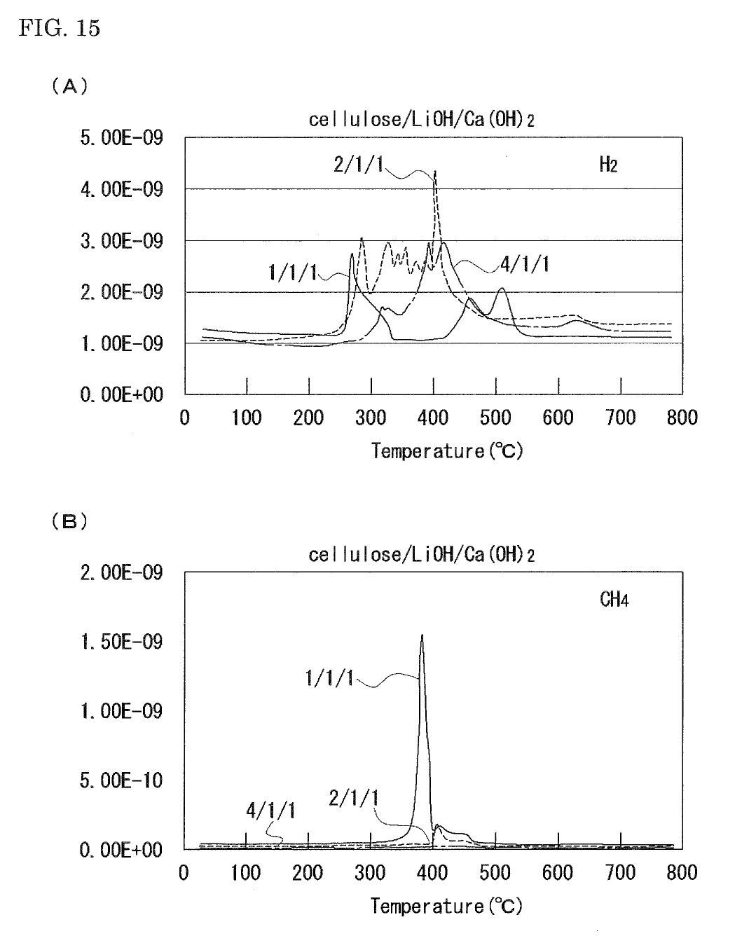

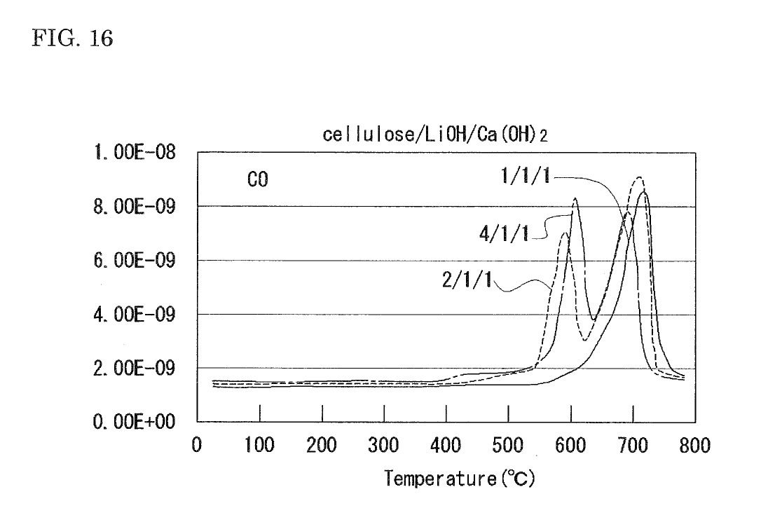

FIG. 15A, FIG. 15B, and FIG. 16 show mass spectra for hydrogen, methane, and CO for each of the MG processing products respectively.

It can be seen from FIGS. 15A, 15B and 16 that

(1) hydrogen and methane are generated within a temperature range from 250 to 550° C. from any of the MG processing products not depending on the molar ratio, and
(2) CO is generated within a temperature range from 550 to 750° C. from any of the MG processing products not depending on the molar ratio.

While the present invention has been described specifically with reference to the preferred embodiments, the invention is not restricted to the embodiments described above and can be modified variously within a range not departing from the gist of the invention.

The energy gas production process according to the invention can be used as a process for producing various kinds of energy gases such as combustible gases and fuel gases for supplying to fuel cells.

Further, the energy gas storage material according to the invention can be used as a material for taking out various kinds of energy gases by a simple and convenient method.

What is claimed is:

1. A process for producing an energy gas comprising:
a MG processing step of co-grinding a mixture of a carbon-, hydrogen-, and oxygen-containing compound, an alkali metal or a compound thereof, and an alkaline earth metal or a compound thereof, thereby obtaining a MG processing product, and
a heating step of heating the MG processing product in an inert atmosphere.

2. The energy gas production process according to claim 1, wherein the alkali metal or the compound thereof contains Li and/or K.

3. The energy gas production process according to claim 1, wherein the alkaline earth metal or the compound thereof contains Ca.

4. The energy gas production process according to claim 1, wherein the MG processing step further includes adding a transition metal or a compound thereof to the mixture and co-grinding the mixture.

5. The energy gas production process according to claim 4, wherein the transition metal or the compound thereof contains one or more of elements selected from Mn, Fe, Co, Ni, and Cu.

6. A process for producing an energy gas comprising:
a MG processing step of co-grinding a mixture of a carbon-, hydrogen-, and oxygen-containing compound, and an alkaline earth metal or a compound thereof (excluding hydroxide), thereby obtaining a MG processing product, and
a heating step of heating the MG processing product in an inert atmosphere.

7. The energy gas production process according to claim 6, wherein the alkaline earth metal or the compound thereof contains Ca.

8. A process for producing an energy gas comprising:
a MG processing step of co-grinding a mixture of a carbon-, hydrogen-, and oxygen-containing compound, an alkaline earth metal or a compound thereof, and a transition metal or a compound thereof (excluding those in which the alkaline earth metal or a compound thereof is Ca(OH)₂ and the transition metal or a compound thereof is Ni(OH)₂), thereby obtaining a MG processing product, and
a heating step of heating the MG processing product in an inert atmosphere.

9. The energy gas production process according to claim 8, wherein the alkaline earth metal or the compound thereof contains Ca.

10. The energy gas production process according to claim 8, wherein the transition metal or the compound thereof contains one or more of elements selected from Mn, Fe, Co, Ni, and Cu.

11. An energy gas storage material obtained by co-grinding a mixture of a carbon-, hydrogen-, and oxygen-containing compound, an alkali metal or a compound thereof, and an alkaline earth metal or a compound thereof.

12. The energy gas storage material according to claim 11, obtained by adding a transition metal or a compound thereof to the mixture and co-grinding the mixture.

13. The energy gas storage material according to claim 12, wherein the size of the transition metal or the compound thereof contained in the MG processing product after co-grinding is 5 nm or less.

14. An energy gas storage material obtained by co-grinding a mixture of a carbon-, hydrogen-, and oxygen-containing compound and an alkaline earth metal or a compound thereof (excluding hydroxide).

15. An energy gas storage material obtained by co-grinding a mixture of a carbon-, hydrogen-, and oxygen-containing compound, an alkaline earth metal or a compound thereof, and a transition metal or a compound thereof (excluding those in which the alkaline earth metal or a compound thereof is Ca(OH)₂ and the transition metal or the compound thereof is Ni(OH)₂).

16. The energy gas storage material according to claim 15, wherein the size of the transition metal or the compound thereof contained in the MG processing product after the co-grinding is 5 nm or less.
